(19) United States
(12) Patent Application Publication
(10) Pub. No.: US 2008/0311949 A1
(43) Pub. Date: Dec. 18, 2008

(54) Determining a Transmission Window for Transmission Bursts of Broadcast Service

(76) Inventors: Henri Markus Koskinen, Espoo (FI); Tommi Tapani Koivisto, Espoo (FI)

Correspondence Address: SLATER & MATSIL, L.L.P., 17950 PRESTON RD, SUITE 1000, DALLAS, TX, 75252-5793, US

(21) Appl. No.: 12/138,658

(22) Filed: Jun. 13, 2008

Related U.S. Application Data
(60) Provisional application No. 60/944,727, filed on Jun. 18, 2007.

(51) Int. Cl. H04Q 7/22; H04B 7/00

(52) U.S. Cl. 455/525; 455/517

(57) ABSTRACT

In an embodiment, a method, apparatus and system are provided for determining a transmission window for transmission bursts of broadcast service. In one embodiment, the apparatus includes a link-terminating element configured to receive a multimedia broadcast and multimedia multicast service message from a network control element. The apparatus also includes a processor configured to define a burst transmission window for the multimedia broadcast and multimedia multicast service message. The apparatus also includes a transceiver configured to transmit the multimedia broadcast and multimedia multicast service message within the burst transmission window.

This application claims the benefit of U.S. Provisional Application No. 60/944,727 entitled “Determining a Transmission Window for Transmission Bursts of Broadcast Service to Reduce Reception Loss in Inter-Cell Mobility,” filed on Jun. 18, 2007, which is incorporated herein by reference.

### TECHNICAL FIELD

The present invention relates, in general, to communications systems and, more particularly, to a system and method for determining a transmission window for transmission bursts of broadcast service to improve inter-cell mobility.

### BACKGROUND

Broadcast and multicast communications are a form of point-to-multipoint communications wherein information is simultaneously transmitted from a single source to multiple destinations. The Third Generation Partnership Project (“3GPP”) Long-Term Evolution (“LTE”) describes an ongoing effort across the industry to improve the Universal Mobile Telecommunications System (“UMTS”) for mobile communications to cope with continuing new requirements and the growing base of users. The goals of this broadly based project include improving communication efficiency, lowering costs, improving services, making use of new spectrum opportunities, and achieving better integration with other open standards. The 3GPP LTE work item should result in new recommendations for standards for the UMTS. The phrase “multimedia broadcast and multimedia multicast service” (“MBMS”) is 3GPP terminology that refers to broadcast and multicast services and related systems associated therewith. The MBMS system is planned to be a part of the LTE.

Single frequency network (“SFN”) (also referred to as “multicast broadcast single frequency network” (“MBSFN”), or “multi-cell point-to-multipoint” (“multi-cell PtM”)) refers to a transmission mode in LTE MBMS where several transmitters simultaneously transmit the same signal over the same frequency channel. The receiving terminals or user equipment combine multiple transmissions from various cells. In order to implement an SFN, each of the transmitting cells is tightly time-synchronized and uses the same time-frequency resources for transmitting the bit-identical content. Thus, SFN operation employs content synchronization of the base stations transmitting an MBMS within, for instance, an associated deployment area. (See, e.g., 3GPP TS 36.300, entitled, “Evolved Universal Terrestrial Radio Access (E-UTRA) and Evolved Universal Terrestrial Radio Access Network (E-UTRAN); Overall Description; Stage 2,” which is incorporated herein by reference.)

Due to the complexity in the synchronization used to implement SFN, additional transmission modes that do not employ such synchronization requirements have been explored. One such transmission mode referred to as single-cell transmission mode does not follow synchronization requirements as strict as those in SFN, and it also allows for more of an independent arrangement of individual transmissions.

If transmissions of neighboring cells or SFNs were left uncoordinated, random phase differences would result between the transmissions from different cells. This state, therefore, would imply that, for every pair of neighboring cells transmitting a given MBMS, user equipment moving from one cell to another in one of the two possible directions would inevitably not receive some service data. While mobility in single-cell broadcast transmission has yet to be addressed in 3GPP LTE radio access network specifications, the previous versions (e.g., UTRAN Release 6), typically provide for data loss minimization during inter-cell mobility using two mechanisms, namely, forward error correction (“FEC”) and multi-cell combining, other than MBSFN reception. (See, e.g., 3GPP TS 25.346, entitled, “Introduction of the Multimedia Broadcast/Multicast Service (MBMS) in the Radio Access Network (RAN); Release 6; Stage 2,” which is incorporated herein by reference.)

For example, UTRAN Release 6 provides for FEC coding on the application layer computed over several seconds' worth of service data at a time. This accumulation of FEC coding typically results in tolerating fairly long (i.e., seconds) interruptions of data reception without any effect on the eventual service quality. One disadvantage of the FEC coding system is that the more recent releases are subject to an agreed requirement limiting the channel switching time for MBMS to less than or equal to one second. With this new proposed timing requirement, the Release 6 application layer FEC coding, having relatively long induced delays, may no longer meet the operational parameters of the new E-UTRAN and, thus, cannot be relied upon in inter-cell mobility.

Multi-cell combined reception, which may be implemented by either soft or selective combining, generally requires synchronization of transmissions to an accuracy equal to one time transmission interval (“TTI”). Multi-cell combination using soft combining is similar to an SFN implemented in E-UTRAN. Selective combination would generally further require the user equipment to receive data from both cells simultaneously, which greatly increases the complexity of managing and implementing such a transmission mode.

Accordingly, what is needed in the art is a system and method for providing timing constraints for the transmission of multimedia broadcast and multimedia multicast service data streams transmitted to user equipment, that accommodate the user equipment moving between cells without loss in the reception of the multimedia broadcast and multimedia multicast service data streams.

### SUMMARY OF THE INVENTION

These and other problems are generally solved or circumvented, and technical advantages are generally achieved, by embodiments of the present invention, which include a method, apparatus, and system for determining a transmission window for transmission bursts of broadcast service. In one embodiment, a communication system includes a network control element, a base station and user equipment. The network control element includes a link-terminating element configured to transmit a multimedia broadcast and multimedia multicast service message. The base station includes a link-terminating element configured to receive the multimedia broadcast and multimedia multicast service message, and a processor configured to define a burst transmission window for the multimedia broadcast and multimedia multicast service message. A transceiver of the base station is configured to transmit the multimedia broadcast and multimedia multicast service message within the burst transmission window. The user equipment includes transceiver configured to receive the multimedia broadcast and multimedia multicast service message within the burst transmission window from the base station. A processor of the user equipment is configured to select another base station to receive another multimedia broadcast and multimedia multicast service message within another burst transmission window after receiving the multimedia broadcast and multimedia multicast service message.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawing, in which:

FIGS. 1 and 2 illustrate system level diagrams of embodiments of communication networks and systems that provide an environment for application of principles of the present invention;

FIG. 3 illustrates a system level diagram of a communication element of a communication system that provides an environment for application of principles of the present invention;

FIG. 4 illustrates a block diagram of an embodiment of a communication system constructed in accordance with principles of the present invention;

FIGS. 5A and 5B illustrate block diagrams of a single-cell transmission pathway constructed according to the principles of the present invention;

FIG. 6 illustrates a block diagram of a communication system constructed in accordance with principles of the present invention;

FIG. 7 illustrates a flowchart of an embodiment of a method of operating a system constructed according to the principles of the present invention;

FIG. 8 illustrates a flowchart of another embodiment of a method of operating a system constructed according to the principles of the present invention; and

FIG. 9 illustrates a block diagram of a communication system constructed in accordance with principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. In view of the foregoing, the present invention will be described with respect to exemplary embodiments in a specific context, namely an E-UTRAN communication system. The invention may also be applied, however, to other types of communication systems.

In operation, the time-averaged data rate in an MBMS is small relative to the instantaneous data rate of its radio transmission. Thus, the service may be transmitted in short bursts that occupy only a fraction of time. For example, the data required to provide a streaming service for one second may be burst transmitted in as little as hundreds of milliseconds, even in the worst case. Such burst transmissions can be utilized to create a certain window of time in which the burst should not be transmitted in neighboring cells, in order to enhance lossless user equipment mobility to another cell. In one aspect, the various embodiments and principles of the present invention describe the determination of this window.

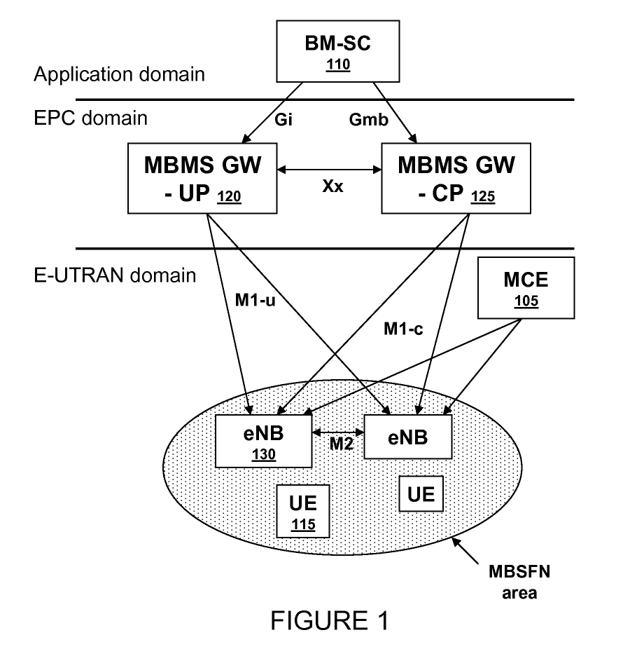

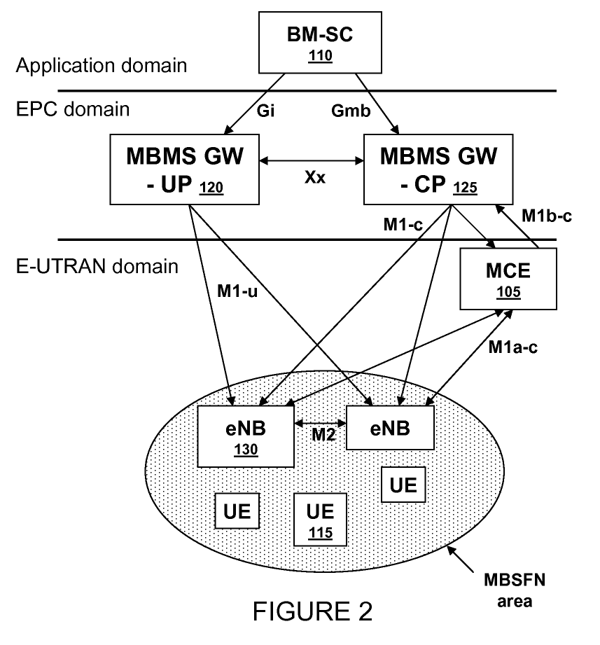

Referring initially to FIGS. 1 and 2, illustrated are system level diagrams of embodiments of communication networks and systems that provide an environment for the application of the various principles of the present invention. The communication networks include 3GPP LTE E-UTRAN employing both single frequency network and single-cell transmission modes. The communication networks of FIGS. 1 and 2 demonstrate light and general MBMS deployment, respectively. A property of the light MBMS deployment (FIG. 1) is that the functionality of a multi-cell MBMS coordination entity (“MCE”) 105 is semi-statically or statically configured in the relevant nodes.

The communication networks of FIGS. 1 and 2 include an application domain with a broadcast/multicast service center (“BM-SC”) 110. The BM-SC 110 serves as an entry point for content delivery services within the communication networks. The BM-SC 110 configures and controls transport bearers for the MBMS to an evolved packet core (“EPC”) domain (e.g., a mobile core network) and an E-UTRAN domain and schedules and delivers transmissions for the MBMS. The BM-SC 110 also provides service announcements and information for user equipment (“UE,” one of which is designated 115) to join MBMS such as, without limitation, a multicast service identifier, Internet protocol multicast addresses, time of transmission, media descriptions, and the like. The BM-SC 110 can also be used to generate subscription records for information transmitted by a content provider and manage security functions specified by 3GPP for a multicast mode.

The EPC domain includes MBMS gateways (“MBMS GWs”) both in a user plane (“MBMS GW-UP”) 120 and a control plane (“MBMS GW-CP”) 125. The link between MBMS GW-UP 120 and MBMS GW-CP 125 is labeled Xx in FIGS. 1 and 2. During session initiation, the MBMS GW-UP 120, with an interface to the BM-SC 110 labeled Gi, assigns a private Internet protocol (“IP”) multicast address used for a user data stream distribution towards the base stations. The MBMS GW-UP 120 entity is also responsible for forwarding IP packets received from the BM-SC 110 to the base stations (“eNBs,” one of which is designated 130) that have joined the private IP multicast group of a particular MBMS stream. In case of an SFN transmission mode, the MBMS GW-UP 120 adds to the forwarded data unit information based on which base stations 130 are able to have an air interface transmission synchronization. In single-cell transmission mode, the MBMS GW-UP 120 may supply burst transmission timing information to the transmitted service data in select embodiments or, in other embodiments, may simply transmit the service data to the base stations. The interface between MBMS GW-UP 120 and base stations 130 is labeled M1-u.

The MBMS GW-CP 125 is a functional entity that takes care of MBMS session management in the EPC domain, which is terminated by an interface labeled Gmb. The MBMS GW-CP 125 delivers MBMS session start/stop messages to the base stations 130 part of the targeted MBMS service area. The interface between the MBMS GW-CP 125 and base stations 130 is labeled M1-c.

The MCE (also known as an “MBMS radio resource management entity” or “operations and maintenance server”) 105 performs radio resource management. In addition, the MCE 105 may be involved in the handling of counting results (e.g., in a shared carrier case). The major property of the light MBMS deployment is that the MCE 105 functionality is semi-statically or statically configured in the relevant nodes. The interface between the MBMS GW-CP 125 and the MCE 105 is labeled M1b-c, and the interface between the MCE 105 and a base station 130 is labeled M1a-c.

The communication networks of FIGS. 1 and 2 also include an E-UTRAN domain with base stations 130 defining a multimedia broadcast single frequency network (“MBSFN”) area for user equipment 115 therein. The base stations 130 are responsible for the air interface operation. The base stations 130 control the mapping of MBMS areas to cells. In the SFN transmission mode, the base stations 130 that are part of the same SFN area should be synchronized. However, in the single-cell transmission mode, the base stations 130 do not have to be synchronized. It should be noted that in select embodiments, base stations 130 are only loosely synchronized for single-cell transmission mode, while in other select embodiments base stations are not synchronized at all. The communication link between the base stations 130 in FIGS. 1 and 2 is labeled M2.

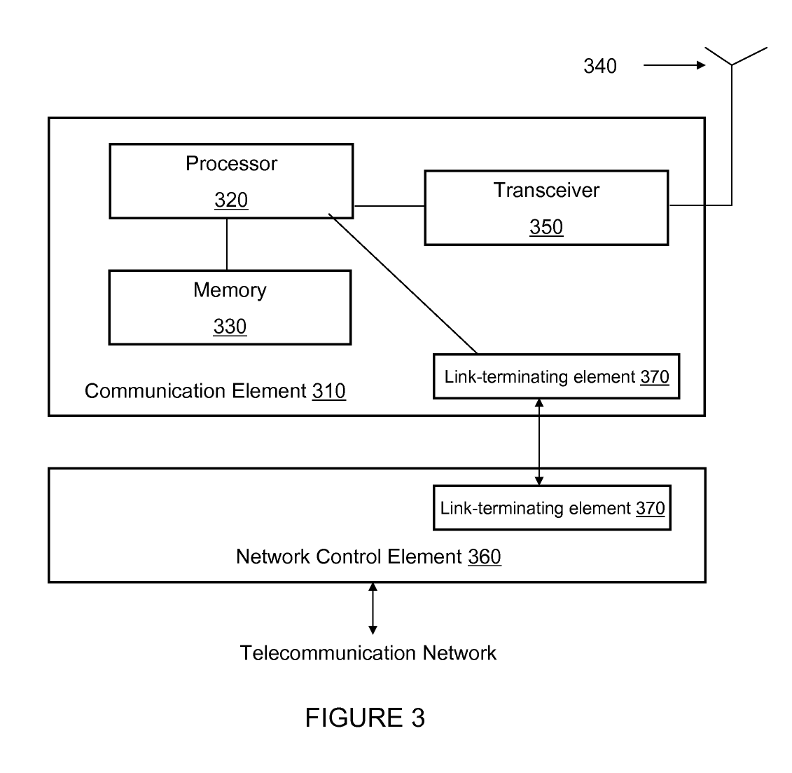

Turning now to FIG. 3, illustrated is a system level diagram of a communication element 310 of a communication system that provides an environment for application of the principles of the present invention. The communication element 310 may represent, without limitation, a base station, a user equipment, such as a terminal or mobile station, a network control element, or the like. The communication element 310 includes, at least, a processor 320, memory 330 that stores programs and data of a temporary or more permanent nature, an antenna 340, and a radio frequency transceiver 350 coupled to the antenna 340 and the processor 320 for bidirectional wireless communications. The communication element may provide point-to-point and/or point-to-multipoint communication services.

The communication element 310, such as a base station in a cellular network, may be coupled to a communication network element, such as a network control element 360 of a public switched telecommunication network. The network control element 360 may, in turn, be formed with a processor, memory, and other electronic elements (not shown). The network control element 360 generally provides access to a telecommunication network such as a public switched telecommunication network (“PSTN”). Access to the telecommunication network may be provided in fixed facilities, such as a base station, using fiber optic, coaxial, twisted pair, microwave communication, or similar link coupled to an appropriate link-terminating element 370. A communication element 310 formed as a user equipment or mobile station is generally a self-contained device intended to be carried by an end user.

The processor 320 in the communication element 310, which may be implemented with one or a plurality of processing devices, performs functions associated with its operation including, without limitation, encoding and decoding of individual bits forming a communication message, formatting of information, and overall control of the communication element 310, including processes related to management of resources. Exemplary functions related to management of resources include, without limitation, hardware installation, traffic management, performance data analysis, tracking of end users and equipment, configuration management, end user administration, management of user equipment, management of tariffs, subscriptions, and billing, and the like. The execution of all or portions of particular functions or processes related to management of resources may be performed in equipment separate from and/or coupled to the communication element 310, with the results of such functions or processes communicated for execution to the communication element 310. The processor 320 of the communication element 310 may be of any type suitable to the local application environment, and may include one or more of general-purpose computers, special-purpose computers, microprocessors, digital signal processors (“DSPs”), and processors based on a multi-core processor architecture, as non-limiting examples.

The transceiver 350 of the communication element 310 modulates information onto a carrier waveform for transmission by the communication element 310 via the antenna 340 to another communication element. The transceiver 350 demodulates information received via the antenna 340 for further processing by other communication elements.

The memory 330 of the communication element 310, as introduced above, may be of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory 330 may include program instructions that, when executed by an associated processor, enable the communication element 310 to perform tasks as described herein. Exemplary embodiments of the system, subsystems and modules as described herein may be implemented, at least in part, by computer software executable by processors of, for instance, the user equipment and the base station, or by hardware, or by combinations thereof. As will become more apparent, systems, subsystems and modules may be embodied in the communication element as illustrated and described above.

According to the principles of the present invention, a method, apparatus, and system for determining a transmission window for transmission bursts of broadcast service is provided herein. In one embodiment, a communication system includes a network control element, a base station and user equipment. The network control element 360 includes the link-terminating element 370 configured to transmit a multimedia broadcast and multimedia multicast service message.

When the communication element 310 performs in accordance with a base station, the link-terminating element 370 is configured to receive the multimedia broadcast and multimedia multicast service message. The processor 320 is configured to define a burst transmission window for the multimedia broadcast and multimedia multicast service message. The transceiver 350 of the base station is configured to transmit the multimedia broadcast and multimedia multicast service message within the burst transmission window.

When the communication element 310 performs as user equipment, the transceiver 350 is configured to receive the multimedia broadcast and multimedia multicast service message within the burst transmission window from the base station. When an event triggers a change of cell, a processor 320 of the user equipment is configured to select another base station to receive another multimedia broadcast and multimedia multicast service message within another burst transmission window after receiving the multimedia broadcast and multimedia multicast service message.

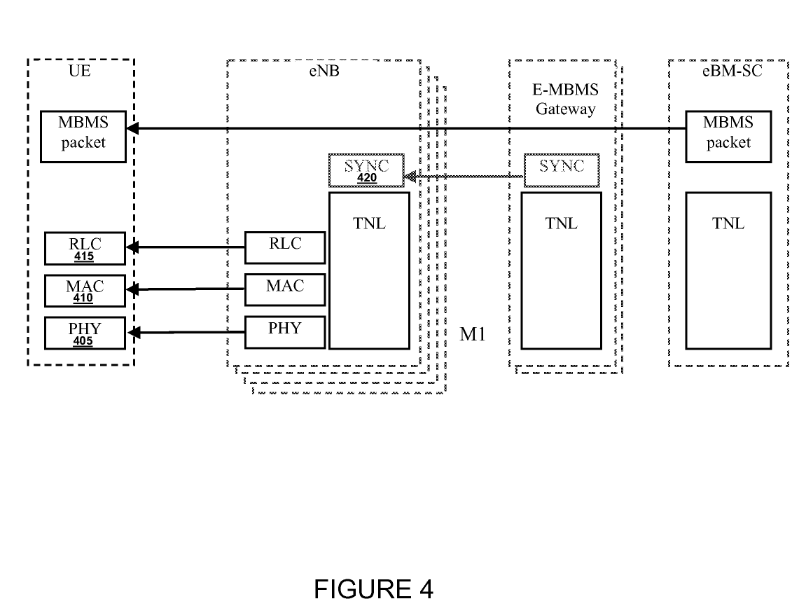

Turning now to FIG. 4, illustrated is a block diagram of an embodiment of a communication system in accordance with principles of the present invention. The communication system supporting MBMS transmission operation includes a broadcast/multicast service center (designated “eBM-SC”), an MBMS GW-UP, a base station (“eNB”) and user equipment (“UE”). The architecture is based on the functional allocation for unicast communications and includes a synchronization subsystem between a transport network layer and a packet data convergence protocol (“PDCP”) layer (not shown) to support a link-layer content synchronization mechanism for SFN transmission mode in addition to single-cell transmission mode.

The user equipment includes a physical resource subsystem (“PHY”) 405, a media access controller (“MAC”) 410, and a radio link controller (“RLC”) 415, a termination entity for radio link control protocol. The physical resource subsystem 405 defines the electrical and the physical specifications for the radio interface for the user equipment. The MAC 410 provides addressing and channel access control mechanisms for the user equipment. For instance, the MAC 410 extracts the MBMS control channel (“MCCH”) and the MBMS transport channel (“MTCH”) from a multicast channel (“MCH”) or a shared channel (“SCH”), depending on deployment scenarios. The RLC 415 provides reordering and reassembly of an MBMS message for the user equipment.

A synchronization (“SYNC”) subsystem 420 in each base station synchronizes the transmission of MBMS messages among different base stations. The SYNC subsystem 420 provides timing indication of radio transmissions for MBMS packets, maintains synchronization, and detects data losses in a number of bytes as well as in a number of packets. The MBMS GW and the eBM-SC include many of the subsystems corresponding to the subsystems of the base station and user equipment, as described above.

In the operation of a single-cell transmission mode in a communication system configured according to one embodiment, the base station receives an MBMS message from a central node (e.g., an MBMS GW-UP). The base station determines a burst transmission window within which the MBMS message is transmitted to user equipment. The transmission window may be defined by an earliest start time (“Sᵢ”), a latest allowed finishing time (“Fᵢ”) for the transmission of the burst, and possibly a timing delay (“Δₜ”) that represents either a synchronization difference in the base stations or transmission delay differences of the MBMS message from the central node. The variable “i” represents the indexing number of the bursts. The parameters, such as the earliest start time (“Sᵢ”) and the latest allowed finishing time (“Fᵢ”), may be provided to the base station by the central node by appending those parameters to the synchronization (“SYNC”) protocol field of the MBMS message packet header. The SYNC protocol is generally used in support of SFN transmission modes, but it is leveraged here to support the execution of single-cell transmission as well. Alternatively, the base station may calculate the parameters used to determine the burst transmission window according to some common network parameters known to all involved base stations. If the transmissions are done within the determined transmission window in all cells, the data loss during cell changes is reduced.

Cell change may be implemented by different methods depending on the specific embodiment of the communication system employed. In a first system type, cell change is controlled by the base stations. Inasmuch as the base stations control the switch, they may issue the switch command at their discretion to reduce service data loss by triggering a cell change between bursts. Alternatively, the user equipment may re-select its own desired cell. In such a system, the user equipment would be configured to make cell changes right after receiving an entire burst from a source cell.

The period between the latest finish time (“Fᵢ”) and successive burst times (“Sᵢ₊₁”) allows the user equipment to change cells between bursts, which reduces the potential for data loss during inter-cell mobility. In determining the burst transmission windows, the earliest start time (“Sᵢ”) and latest finish time (“Fᵢ”) are needed. In addition, the successive burst start time (“Sᵢ₊₁”) may be determined and used as the latest time instant by which the cell change should have been made. In a typical case, the bursts are periodic with some constant periodic value (“T”) separating successive bursts. In this case, the successive burst time may be determined from the current burst start time according to the formula:

Sᵢ₊₁=Sᵢ+T. (1)

In another case, the starting times may be explicitly signaled to the base stations and do not need to be periodic. In determining the finishing time (“Fᵢ”), the known time needed for a user equipment to prepare for reception from a new cell (“T_{sync}”) may also be utilized. Typically, the time (“T_{sync}”) value is along the order of tens of milliseconds or less than 100 milliseconds (“ms”) in the LTE MBMS system. In order to avoid data losses, the successive burst time and finishing time of the current burst meet the condition defined in the formula:

Sᵢ₊₁≧Fᵢ+Δₜ+T_{sync}. (2)

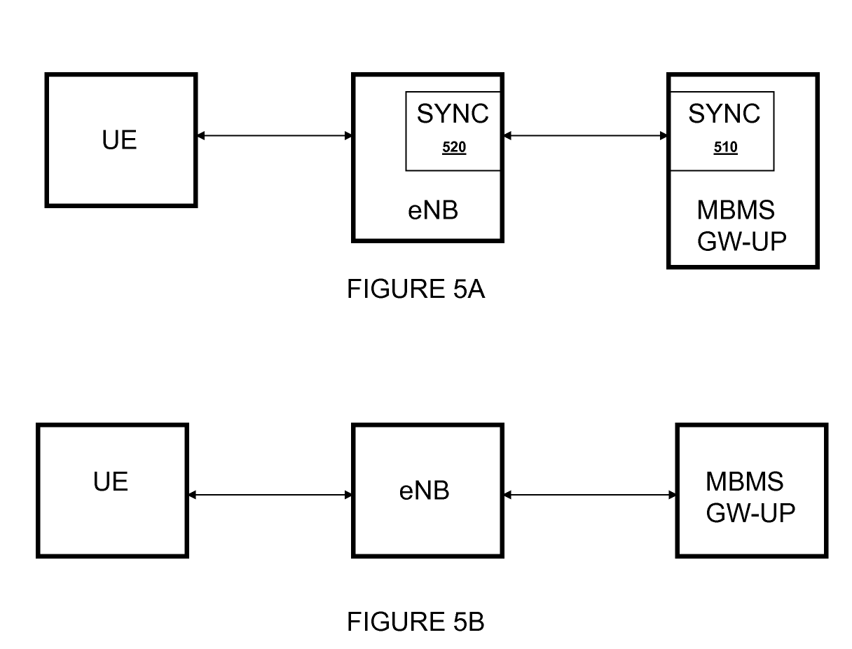

Turning now to FIG. 5A, illustrated is a block diagram of a single-cell transmission pathway configured according to the principles of the present invention. In the illustrated embodiment, MBMS GW-UP provides the earliest start time (“Sᵢ”) and latest finish time (“Fᵢ”). The earliest start time (“Sᵢ”) and latest finish time (“Fᵢ”) parameters are provided to the base station to determine the burst window within which to transmit the MBMS message on to the user equipment. While sending the MBMS packets from MBMS GW-UP, the earliest start time (“Sᵢ”) and latest finish time (“Fᵢ”) are calculated by MBMS GW-UP and appended to the header information in the SYNC protocol in accordance with a SYNC subsystem 510 of a processor thereof. This information, along with the MBMS message is transmitted to the base station.

In the illustrated embodiment, the base station is loosely synchronized with other base stations (not shown). The synchronization scheme allows or tolerates an assumed timing delay (“Δₜ”) of between 10 ms and 100 ms. As the base station receives the MBMS message from MBMS GW-UP, it uses the earliest start time (“Sᵢ”) and latest finish time (“Fᵢ”) from the SYNC protocol to establish the burst transmission window in accordance with a SYNC subsystem 520 of a processor thereof. Additionally, the start time of the successive burst (“Sᵢ₊₁”) may be determined if needed.

It should be noted that one example of a synchronization mechanism that may be compatible with various additional and/or alternative embodiments of the present invention is defined by IEEE Standard 1588-2002 IEEE Standard for a Precision Clock Synchronization Protocol for Networked Measurement and Control Systems, sponsored by IEEE Instrumentation and Measurement Society (2002), which is incorporated herein by reference and is available online at http://ieeexplore.ieee.org/xpls/abs_all.jsp?tp=&isnumber=22465&arnumber=1048550&punumbe r=8117.

Turning now to FIG. 5B, illustrated is a block diagram of a single-cell transmission pathway configured according to the principles of the present invention. In the illustrated embodiment, the base station calculates the parameters to determine the burst window within which to transmit the MBMS message to the user equipment. Instead of explicitly signaling each earliest start time, a single reference value (“S”) and a periodic time value (“T”) are used. In the embodiment illustrated in FIG. 5B, the base stations are not synchronized with any other base station in the MBMS area. Thus, the time delay (“Δₜ”) is determined according to the transmission delay difference between the central node (i.e., MBMS GW-UP) and the base stations. In practice, such a transmission delay is along the order of less than or equal to 60 ms. The base station may then calculate the latest finish time (“Fᵢ”) using formula (2) rearranged to solve for (“Fᵢ”):

Fᵢ=Sᵢ₊₁−Δₜ−T_{sync}. (3)

Based on formula (1), formula (3) may be rewritten such that the base station may calculate the latest finish time (“Fᵢ”) according to the formula:

Fᵢ=(Sᵢ+T)−Δₜ−T_{sync}. (4)

It should be noted that in each of the various embodiments of the present invention, provisions are made to select starting and finishing times of successive bursts so that, taking the variation in the transmission delays and/or inaccuracy of clock synchronization into account, for any earliest start time (“Sᵢ”), any user equipment should be able to perform a cell change between receiving a burst by the latest finish time (“Fᵢ”) in a previous cell and receiving a subsequent burst at a subsequent burst start time (“Sᵢ₊₁”) in a new cell.

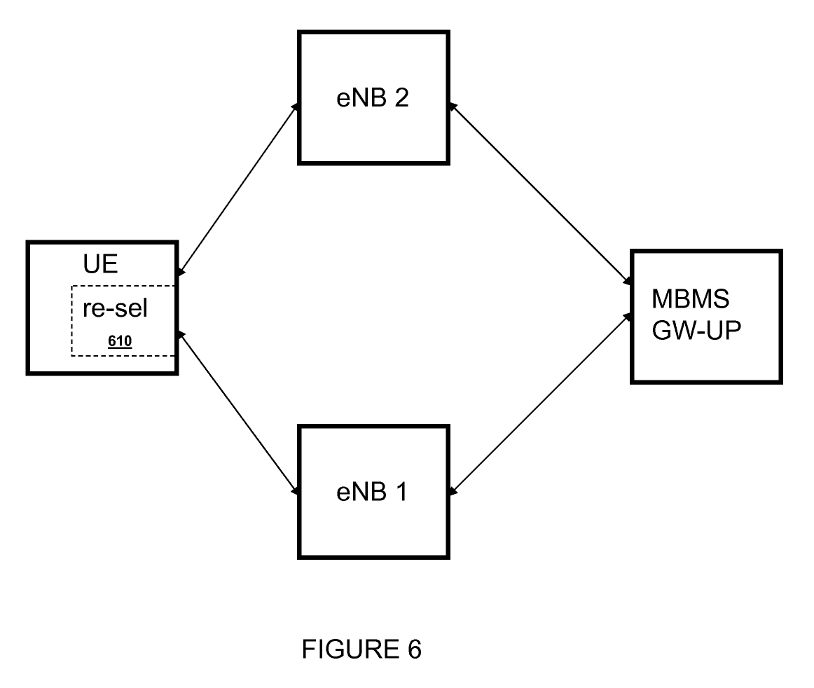

Turning now to FIG. 6, illustrate is a block diagram of a communication system constructed in accordance with principles of the invention. After receiving MBMS message from MBMS GW-UP, a first base station (designated “eNB 1”) calculates the burst window and begins the burst transmission of the appropriate MBMS message. In a first embodiment represented in FIG. 6, the first base station and a second base station (designated “eNB 2”) control cell change orders to user equipment (designated “UE”) signaling whether or not the user equipment may change cells. At its discretion, the first base station may issue such a change order to the user equipment after the burst transmission is complete. By configuring the first and second base stations to issue change orders after completing burst transmissions, loss of service data due to cell change is reduced (e.g., minimized).

It should be noted that an additional and/or alternative embodiment is also represented in FIG. 6. In the additional and/or alternative embodiment, the user equipment includes a re-selection subsystem (“re-sel”) 610 embodied in a processor that initiates selection or re-selection of cells to join. Therefore, in the additional and/or alternative embodiment discussed here, the first and second base stations do not control cell change. The re-selection subsystem 610 of the user equipment is specifically configured to change cells (or select another base station) immediately after receiving an entire burst transmission from the source cell (e.g., the first base station), thereby enabling the user equipment to receive the next entire burst transmission from the target cell (e.g., the second base station), once certain criteria on the signal reception qualities from the two cells are fulfilled.

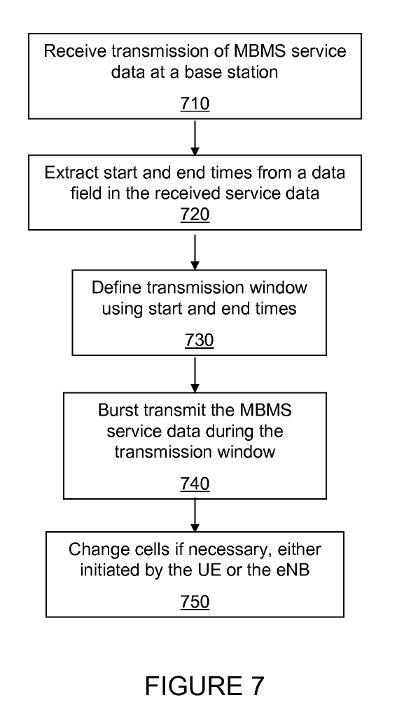

Turning now to FIG. 7, illustrated is a flowchart of an embodiment of a method of operating a system according to the principles of the present invention. The base station receives transmission of MBMS message at a step 710 and then extracts start and end times from a data field in the received data at a step 720. The base station then defines a transmission window for transmitting the MBMS message to the user equipment using the start and end times at a step 730 and burst transmits the MBMS message during the transmission window at a step 740. At the end of the burst transmission, a cell change occurs, if necessary, either initiated by the user equipment or the base station at a step 750.

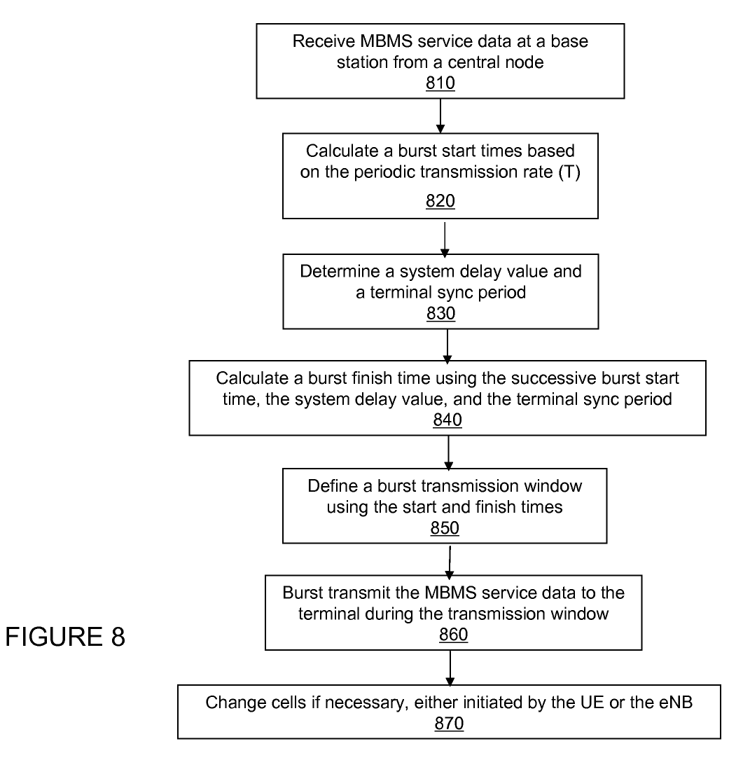

Turning now to FIG. 8, illustrated is a flow chart of another embodiment of a method of operating a system according to the principles of the present invention. The base station receives MBMS message at a base station from a central node at a step 810. The base station calculates burst start times based on the periodic rate (“T”) at a step 820. The base station then determines a system delay value and the user equipment synchronization period at a step 830 and calculates a burst finish time using the successive burst start time, the delay, and user equipment synchronization period at a step 840. The start and end times are thereafter used to define a transmission window at a step 850, after which the MBMS message is burst transmitted to the user equipment during the window at a step 860. At the end of the burst transmission, a cell change occurs, if necessary, either initiated by the user equipment or the base station at a step 870.

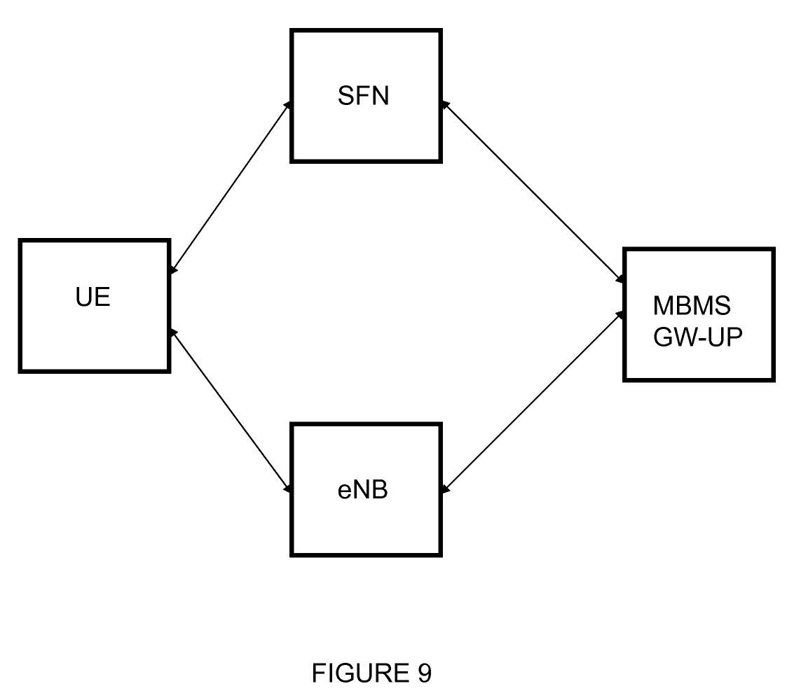

Turning now to FIG. 9, illustrated is a block diagram of a communication system configured in accordance with the principles of the present invention. While the previous examples described application of the various embodiments to only single-cell transmission mode networks, the principles of the present invention may also be applied in embodiments that include an SFN. A user equipment (designated “UE”) views an SFN as just another cell (designated “SFN”). Therefore, the user equipment may change between any combination of single-cell transmission mode base stations (designated “eNB”) and SFNs without meeting the strict synchronization requirements of an SFN.

In operation, a base station receives the MBMS message from the MBMS GW-UP and determines a time window within which it will burst transmit the MBMS message to the user equipment. After receiving the entire burst transmission from the base station, the user equipment may then switch cells to the SFN. The user equipment would, thereafter, receive the successive burst of MBMS message from the SFN. Alternatively, in network controlled mobility (i.e., cell change), through exchange of RRC messages between the user equipment and base stations (e.g., measurement reports from the user equipment to the base station and cell change orders from the base station to the user equipment), a cell change may be ordered by the base stations after completion of a full burst.

Thus, a system and method have been introduced for use in a communication system. The communication system is configured to provide a single-cell transmission mode for MBMS messages. The MBMS message is received at a base station (“eNB”) from a central node (e.g., MBMS GW-UP). The base station determines a transmission window in which the media access controller (“MAC”) via a transceiver of the base station will burst transmit the MBMS message to user equipment. The determination is made by the base station using a system time delay and a burst transmission interval. Once the burst transmission is completed, user equipment cell changes can be directed to occur by messages of radio resource control (“RRC”) protocol, which lies in the control plane above the packet data convergence protocol (“PDCP”). The cell changes are, therefore, scheduled or initiated between burst transmissions to reduce (e.g., minimize) the service data loss during inter-cell mobility. In one embodiment of the communication system, the base stations are loosely synchronized. In such systems, the system time delay is manifested as, for instance, the maximum time difference between the clocks of any two base stations.

In another embodiment of the communication system, the base stations are not synchronized. In these embodiments, the system time delay is manifested as, for instance, the maximum transmission delay difference in service data transmissions between the central node and the base stations. Here, the data arrival time at the base stations is taken as a base station-specific time reference from which the system time delay is calculated by, for instance, the maximum delay difference relative to the data arrival times.

In another embodiment of the communication system, the burst transmission interval is provided to the base station by the central node. In these systems, the central node calculates the earliest transmission start time and the latest transmission finish time, and sends those parameters to the base station as a part of the MBMS message transmission. The base station then determines the transmission window using those specific parameters. Additionally, the base station may calculate the successive earliest start time using these specific parameters in addition to the system time delay and the time period it takes the user equipment to prepare for receiving from a different cell (i.e., user equipment synchronization period). This calculated successive earliest start time may then be used by the base station in monitoring the transmission windows to ensure the burst transmission times do not overlap or occur too frequently to allow the user equipment to change cells between bursts.

Additional and/or alternative embodiments of the communication system provide for the base stations to implicitly calculate the parameters used for determining the transmission window. By using a single reference value start time, instead of a signal for each burst, and a standard transmission period, the base station may calculate the burst starting times. Moreover, using this starting time calculation with the system delay value and the user equipment synchronization period, the base station may also calculate the latest end time for the bursts. Thus, the base station may independently determine the transmission window for bursting the MBMS message to the user equipment.

In selected embodiments of the communication system, base stations control cell change in the user equipment. In such systems, the base stations are configured to signal cell change after a complete burst has occurred. By directing cell changes to occur between burst transmissions, service data loss is reduced (e.g., minimized) during inter-cell mobility. Additional and/or alternative embodiments of the communication system provide for the user equipment to select and/or re-select cell participation. In these systems, the user equipment is configured to change cells after receiving a complete burst transmission of the MBMS message. Again, the configuration of the user equipment supports cell change between transmission bursts.

As described above, the exemplary embodiment provides both a method and corresponding apparatus consisting of various modules providing functionality for performing the steps of the method. The modules may be implemented as hardware (including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof as described herein. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus, comprising:
a link-terminating element configured to receive a multimedia broadcast and multimedia multicast service message from a network control element;
a processor configured to define a burst transmission window for said multimedia broadcast and multimedia multicast service message; and
a transceiver configured to transmit said multimedia broadcast and multimedia multicast service message within said burst transmission window.

2. The apparatus as recited in claim 1 wherein said processor includes a synchronization subsystem and said burst transmission window is defined using an earliest start time and a latest finishing time of said multimedia broadcast and multimedia multicast service message.

3. The apparatus as recited in claim 1 wherein said multimedia broadcast and multimedia multicast service message includes a header with an earliest start time and a latest finishing time of said multimedia broadcast and multimedia multicast service message transmission.

4. The apparatus as recited in claim 1 wherein said burst transmission window is independently defined by said apparatus according to a common network parameter for a communication system employing said apparatus.

5. The apparatus as recited in claim 1 wherein said network control element is a multimedia broadcast and multimedia multicast service gateway.

6. The apparatus as recited in claim 1 wherein said apparatus is configured to signal a cell change to user equipment after transmitting said multimedia broadcast and multimedia multicast service message.

7. The apparatus as recited in claim 1 wherein said apparatus operates in a single frequency network.

8. The apparatus as recited in claim 1 wherein said apparatus is a base station of a communication system.

9. An apparatus, comprising:
means for receiving a multimedia broadcast and multimedia multicast service message from a network control element;
means for defining a burst transmission window for said multimedia broadcast and multimedia multicast service message; and
means for transmitting said multimedia broadcast and multimedia multicast service message within said burst transmission window.

10. The apparatus as recited in claim 9 further comprising means for signaling a cell change to user equipment after transmitting said multimedia broadcast and multimedia multicast service message.

11. A computer program product comprising program code stored in a computer readable medium configured to receive a multimedia broadcast and multimedia multicast service message from a network control element, define a burst transmission window for said multimedia broadcast and multimedia multicast service message, and transmit said multimedia broadcast and multimedia multicast service message within said burst transmission window.

12. The computer program product as recited in claim 11 wherein said program code stored in said computer readable medium is configured to signal a cell change to user equipment after transmitting said multimedia broadcast and multimedia multicast service message.

13. A method, comprising:
receiving a multimedia broadcast and multimedia multicast service message from a network control element;
defining a burst transmission window for said multimedia broadcast and multimedia multicast service message; and
transmitting said multimedia broadcast and multimedia multicast service message within said burst transmission window.

14. The method as recited in claim 13 wherein said defining is defined using an earliest start time and a latest finishing time of said multimedia broadcast and multimedia multicast service message.

15. The method as recited in claim 13 wherein said multimedia broadcast and multimedia multicast service message includes a header with an earliest start time and a latest finishing time of said multimedia broadcast and multimedia multicast service message transmission.

16. The method as recited in claim 13 wherein said burst transmission window is independently defined according to a common network parameter for a communication system employing said method.

17. The method as recited in claim 13 wherein said network control element is a multimedia broadcast and multimedia multicast service gateway.

18. The method as recited in claim 13 further comprising signaling a cell change to user equipment after transmitting said multimedia broadcast and multimedia multicast service message.

19. The method as recited in claim 13 wherein said method operates in a single frequency network.

20. The method as recited in claim 13 wherein said method is performed by a base station of a communication system.

21. An apparatus, comprising:
a transceiver configured to receive a first multimedia broadcast and multimedia multicast service message within a first burst transmission window from a first base station; and
a processor configured to select a second base station to receive a second multimedia broadcast and multimedia multicast service message within a second burst transmission window after receiving said first multimedia broadcast and multimedia multicast service message.

22. The apparatus as recited in claim 21 wherein said processor includes a re-selection subsystem configured to select said second base station.

23. The apparatus as recited in claim 21 wherein said apparatus operates in a single frequency network.

24. The apparatus as recited in claim 21 wherein said apparatus is user equipment of a communication system.

25. An apparatus, comprising:
means for receiving a first multimedia broadcast and multimedia multicast service message within a first burst transmission window from a first base station; and
means for selecting a second base station to receive a second multimedia broadcast and multimedia multicast service message within a second burst transmission window after receiving said first multimedia broadcast and multimedia multicast service message.

26. The apparatus as recited in claim 25 wherein said apparatus operates in a single frequency network.

27. A computer program product comprising program code stored in a computer readable medium configured to receive a first multimedia broadcast and multimedia multicast service message within a first burst transmission window from a first base station, and select a second base station to receive a second multimedia broadcast and multimedia multicast service message within a second burst transmission window after receiving said first multimedia broadcast and multimedia multicast service message.

28. A method, comprising:
receiving a first multimedia broadcast and multimedia multicast service message within a first burst transmission window from a first base station; and
selecting a second base station to receive a second multimedia broadcast and multimedia multicast service message within a second burst transmission window after receiving said first multimedia broadcast and multimedia multicast service message.

29. The method as recited in claim 28 wherein said selecting is performed by a processor with a re-selection subsystem configured to select said second base station.

30. The method as recited in claim 28 wherein said method is performed in a single frequency network.

31. A communication system, comprising:
a network control element including a link-terminating element configured to transmit a multimedia broadcast and multimedia multicast service message;
a base station, including:
a link-terminating element configured to receive said multimedia broadcast and multimedia multicast service message,
a processor configured to define a burst transmission window for said multimedia broadcast and multimedia multicast service message, and
a transceiver configured to transmit said multimedia broadcast and multimedia multicast service message within said burst transmission window; and
user equipment, including:
a transceiver configured to receive said multimedia broadcast and multimedia multicast service message within said burst transmission window from said base station; and
a processor configured to select another base station to receive another multimedia broadcast and multimedia multicast service message within another burst transmission window after receiving said multimedia broadcast and multimedia multicast service message.

32. The communication system as recited in claim 31 wherein said processor of said base station includes a synchronization subsystem and said burst transmission window is defined using an earliest start time and a latest finishing time of said multimedia broadcast and multimedia multicast service message.
